(19) United States
(12) Patent Application Publication
(10) Pub. No.: US 2016/0286832 A1
(43) Pub. Date: Oct. 6, 2016

(54) METHODS OF FEEDING ANIMALS FERMENTATION CELL MASS

(71) Applicant: ARCHER DANIELS MIDLAND COMPANY, Decatur, IL (US)

(72) Inventors: Stephanie Block, Bement, IL (US); Paul Hanke, Urbana, IL (US); Michael Cecava, Monitcello, IL (US); James Lindquist, Clinton, IL (US); Travis Nelson, Decatur, IL (US); Leif Solheim, Decatur, IL (US)

(21) Appl. No.: 15/036,469

(22) PCT Filed: Nov. 14, 2014
(86) PCT No.: PCT/US14/65607

§ 371 Date: May 13, 2016

Related U.S. Application Data
(60) Provisional application No. 61/904,536, filed on Nov. 15, 2013.

(51) Int. Cl. A23K 10/16; A23K 50/80; A23K 20/142; A23K 50/30; A23K 50/10; A23K 10/14; A23K 50/75

(52) U.S. Cl. CPC A23K 10/16; A23K 10/14; A23K 50/80; A23K 50/75; A23K 50/30; A23K 50/10; A23K 20/142

(57) ABSTRACT

Methods of feeding animals are disclosed. The method includes feeding a disrupted cell mass to an animal at an amount of at least 0.5% of the animal's diet. The cell mass may be disrupted using enzymatic, chemical, or physical disruption. The disrupted cell mass may be used as a protein source for the animal.

### CROSS-REFERENCE TO RELATED APPLICATIONS

This application claims priority to U.S. Provisional Patent Application No. 61/904,536, filed Nov. 15, 2013, the contents of the entirety of which is incorporated by this reference.

### TECHNICAL FIELD

The present invention relates generally to animal feeds, more particularly, the present invention relates to methods of feeding cell masses to animals.

### BACKGROUND OF THE INVENTION

The production of amino acids such as glutamic acid, L-arginine, threonine, or lysine results in an amino acid rich fraction that is used as a source of amino acids in food, feed, pharmaceuticals, and industrial applications. Some amino acids are produced using Corynebacterium glutamicum in a batch, fed-batch, or continuous fermentation process. In one process, once the amino acid concentration in the fermentation broth reaches a desired level, the pH of the fermentation broth is reduced to a pH of between 3.5 to 4.5 using an acid, such as sulfuric acid. The fermentation broth is next heated to temperatures between 55 and 65° C. in order to inactivate the production culture used in the fermentation. The primary amino acid product can then be removed and the remaining biomass is a high protein material in a dilute, aqueous state, such as less than 15% solids.

The Corynebacterium glutamicum cell mass and other cell masses recovered from conventional processing schemes have limited feed value as low-solids fermentation masses. The feeding value of such Corynebacterium glutamicum cell mass and other cell masses is also limited by indigestible cell constituents, the possible presence of anti-nutritional fractions in the cell wall, an imbalance of protein composition, or combinations of any of such factors. These limitations restrict the use of such cell masses to low feeding rates (i.e., less than 5% of a daily feed) and potentially prohibits the use of such cell masses in rations formulated for rapidly growing animals which require highly digestible feeds. What are needed are processes for producing improved fermentation cell masses for use in animal feeds.

### SUMMARY OF THE INVENTION

In each of its various embodiments, the present invention fulfills these needs and discloses processes that are able to improve the acceptability and digestibility of cell masses, thus, improving the use of such cell masses as feed ingredients.

In one embodiment, a method of feeding an animal includes feeding a disrupted cell mass to the animal at an amount of at least 0.5% of the animal's diet.

### BRIEF DESCRIPTION OF THE DRAWINGS

FIG. 1 shows one embodiment of a processing schematic of a fermentation process that may be a source of the cell mass of the present invention.

### DETAILED DESCRIPTION OF THE INVENTION

The present invention discloses novel methods of modifying biomasses for use as animal feed. In one embodiment, a method of feeding an animal comprises disrupting a cell mass obtained from a fermentation, thus producing a disrupted cell mass and feeding the disrupted cell mass to an animal at an amount of at least 0.5% of the animal's diet. In one embodiment, the disruption may be performed on a cell mass obtained from a fermentation process and in another embodiment, whole cells from the fermentation process may be separated from the fermentation process to produce the cell mass.

In an embodiment, the cell mass of the present invention may be a fermentation biomass used to produce an amino acid (e.g., lysine, threonine, methionine), an organic acid (e.g., lactic acid, citric acid, glutamic acid, fumarate, malate, succinate), a vitamin, a biofuel (e.g., ethanol), a lipid, a nutritional supplement, a chemical precursor, riboflavin, biotin, xanthan, astaxanthan, eicosapentaenoic acid, docosahexaenoic acid, or other commercially available fermentation product. In another embodiment, the cell mass may comprise an organism such as a fungus, a bacteria, a yeast, or an algae. In a further embodiment, the cell mass may be of a Corynebacterium origin, a Brevibacterium origin, a Lactococcus origin, a Bacillus origin, a Candida origin, a Saccharomyces origin, an Aspergillus origin, a Schizosaccharomyces origin, an Escherichia origin, a Rhizopus origin, a Torulaspora origin, a Yarrowia origin, a Brettanomyces origin, a Zygosaccharomyces origin, an Actinomycetes origin, a Dietzia origin, Bifidobacterium origin, or combinations of any thereof.

The cell mass may be disrupted by a variety of methods including, but not limited to, enzymatic, chemical, and/or physical disruption methods. In one embodiment, the cell mass may be disrupted using pH adjustment, heating, or a combination thereof. In another embodiment, the cell mass may be disrupted using enzyme treatment, impingement, or a combination thereof performed on whole cells in the cell mass, where such treatments would be useful at neutral pH. Processes performed on live cells may be useful since no prior kill step would be required after fermentation. However, in another embodiment, the processes of disrupting cells of the present invention may also be performed on cell masses subjected to kill steps including, but not limited to, pH adjustment (e.g., acidification) and/or heat treatment. Once the cell mass is disrupted, it may be fed to an animal as a high-protein liquid feedstuff or subsequently dried and fed as a dry feed ingredient. Various enzymes may be used to disrupt cell masses. Enzymes that may be used include, but are limited to, lysozyme, mutanolysin, protease, xylanase, hemicellulose, muramidase, amidase, peptidoglycan hydrolase, lytic transglycosylase, peptidase, carboxypeptidase, and/or other enzymes used in animal feeds for protein or carbohydrate digestion.

In a further embodiment, the cell mass may be disrupted using various mechanical or physical disruption methods. Such methods include, but are not limited to, sonication, homogenization, impingement, bead beating, high pressure gradient, osmotic gradient, autoclaving, heating, freezing, freeze/thawing, French pressing, alkalization, acidification, treatment with a surfactant, treatment with a chelating agent, or combinations of any thereof. Such physical disruption methods improve the value of the cell masses without further processing to extract cell constituents. In essence, the disruption of the whole cell mass without removing any constituents improves the overall recovery of digestible nutrients that may be fed to animals, thus, reducing the presence of any waste streams.

Impingement refers to the collision of cells with solids spheres in an enclosed, agitated system and may also be referred to as bead beating. Bead beating is often used in processing schemes to release intercellular fractions into solution for subsequent extraction. Bead beating may also be used to produce cell wall fractions which remain in insoluble fractions, where the insoluble fractions may be concentrated by centrifuging or precipitation.

The disrupted cell mass may be subjected to further processing. In one embodiment, the disrupted cell mass may be dried. The drying process may include, without limitation, spray drying, drum drying, or other known drying process. In an alternative embodiment, the disrupted cell mass may be used in a liquid form, a wet paste, a concentrated evaporated form, a centrifuged form, or used without being dried.

In an embodiment, the disrupted cell mass may be densified. Types of densification include, but are not limited to, passing the disrupted cell mass through a pellet mill or other type of compression to densify the disrupted cell mass.

The disrupted cell masses may be fed to a variety of animals including, but not limited to fish, poultry, swine, ruminants, bovines, or other commercially raised animal. The disrupted cell mass may be used as a protein source to feed the animal and fed at amounts ranging from 0.5-20% by weight, 1-15% by weight, or 2-10% by weight of the animal's diet.

The following exemplary, non-limiting examples are provided to further describe the embodiments presented herein. Those having ordinary skill in the art will appreciate that variations of these Examples are possible within the scope of the invention.

### EXAMPLE 1

### Methods to Increase Soluble Protein Content of Cell Mass

A series of laboratory trials were initiated to investigate processing methods aimed at disrupting the cellular structure of Corynebacterium glutamicum fermentation mass. The rupture of cells releases soluble cell material into solution and solubilized protein may be measured indirectly by spectrophotometric techniques which measure the binding of protein with a stain. The Bradford assay measures protein reaction with Coomassie Blue dye, and this assay was used to determine the effects of various processing methods on cellular disruption.

Corynebacterium glutamicum cells were collected after lysine production and subsequent lysine removal. Cells were treated with 0.1% lysozyme in an aqueous solution of 10-15% solids for 10-14 hours at 30° C. and dried. The enzyme-treated cells were evaluated in bench top digestion tests and after scale-up in an animal feeding trial.

Methods of preparation. About 1 gallon of cells were obtained from a lysine production fermentation after UF filtration. The cells had a native pH of about 3.1 and a pH of 3.05 after washing (as described herein). The washing included rinsing the cells 2 times with distilled water. For the first rinse, the cells were centrifuged at 8,000 rpm, centrifuged at 10,800×G for 10 minutes, and the liquid was poured off The cells were re-suspended. For the second rinse, the cells were centrifuged at 5,000 rpm, centrifuged at 4,225×G for 10 minutes, and the liquid was poured off. The cells were re-suspended and stored in a refrigerator until further processing.

The cells were subjected to a variety of treatments and the efficacy of the treatments was determined by measuring the release of protein from the cells into solution. The treatments are listed and described in Table 1.

TABLE 1
Processing conditions of Example 1.

| Processing | |
|---|---|
| treatment | Description |
| Enzyme | lysozyme (L-6876 brand lysozyme, Lot 65H7025, |
| | available from Sigma, St. Louis, MO) solution in 0.01 |
| | Tris solution |
| Autoclave | autoclaved 20 minutes on Liquid setting, 120° C. at 19 PSI |
| French Press | 10,000 cell pressure, repeated twice |
| Sonication | Branson Sonifier 450. 35% output for a wave |
| | amplitude of 40-125 microns. |
| pH | Adjust pH to 7 using pH 8 Tris buffer. Used approx. 4 mLs |
| adjustment | Tris with ~20 mL cells. |
| impingement | 0.2-0.3 micron beads. 1 minute up to 10 minutes. |
| Freeze Thaw | 3 x - using dry ice and acetone to freeze and water |
| | bath to thaw approximately 4 mL of cells. |

Various processes of disrupting cells were performed as described in Table 2, along with the results of the various processes using a Bradford assay.

TABLE 2
Results of various processing conditions for Example 1.

| | OD at | | OD of disrupted cells |
|---|---|---|---|
| Sample ID | 595 | Blank | (minus the Blank) |
| Native | 0.447 | 0.4006 | 0.0464 |
| Native + autoclaved | 0.6032 | 0.4006 | 0.2026 |
| Native + 4 min. sonication | 0.466 | 0.4006 | 0.0508 |
| Native + enzyme (pH 4.5) + impingement | 0.9548 | 0.4006 | 0.5396 |
| Native + enzyme (pH 4.5) + sodium dodecyl | 0.963 | 0.4006 | 0.5478 |
| sulfate (SDS; detergent) | | | |
| Native + 10 min. impingement | 0.5395 | 0.4006 | 0.1243 |
| Native + 1 min. 40 sec. sonication | 0.5017 | 0.4006 | 0.0865 |
| Native + enzyme (1 hr.) | 0.7114 | 0.4006 | 0.3108 |
| Native + enzyme (4.5 hr.) | 0.8014 | 0.4006 | 0.3862 |
| Native + freeze/thaw | 0.4264 | 0.4006 | 0.0258 |
| Native (pH 7) | 0.6449 | 0.4152 | 0.2443 |
| Native + French pressed | 0.5298 | 0.4152 | 0.1146 |
| Native + 10% SDS | 0.4689 | 0.4152 | 0.0537 |
| Washed (pH 3.0-4.0) | 0.4224 | 0.4152 | 0.0218 |
| Washed + autoclaved | 0.6896 | 0.4152 | 0.289 |
| Washed (pH 7) | 0.7311 | 0.4152 | 0.3305 |
| Washed + 4 min. sonication (pH 3.0-4.0) | 0.4573 | 0.4152 | 0.0421 |
| Washed + enzyme (pH 4.5) + bead beating | 1.1139 | 0.4152 | 0.6987 |
| Washed + enzyme (pH 4.5) + SDS | 1.0907 | 0.4152 | 0.6755 |
| Washed + 10 min. impingement | 0.4331 | 0.4152 | 0.0179 |
| Washed + 1 min. 40 sec. sonication | 0.4259 | 0.4152 | 0.0107 |
| Washed + enzyme (1 hr.) | 0.8624 | 0.4152 | 0.4618 |
| Washed + enzyme (4.5 hr.) | 0.9215 | 0.4152 | 0.5063 |
| Washed + freeze/thaw | 0.4091 | 0.4152 | 0.0085 |
| Washed + French pressed | 0.4565 | 0.4152 | 0.0413 |
| Washed + 10% SDS | 0.4384 | 0.4152 | 0.0232 |

This Example demonstrated that the various forms of disruptive processes lead to the release of protein from the cells and into solution. The detergent, enzyme, or mechanical disruption increased protein release greater than the sonication, freeze/thawing, or the use of high pressure (French press). Based on the results of Example 2, it appears that the processes using enzymes and/or mechanical disruption were the most effective processes for disruption of the cells.

### EXAMPLE 2

### Methods of Processing to Increase Protein Digestibility

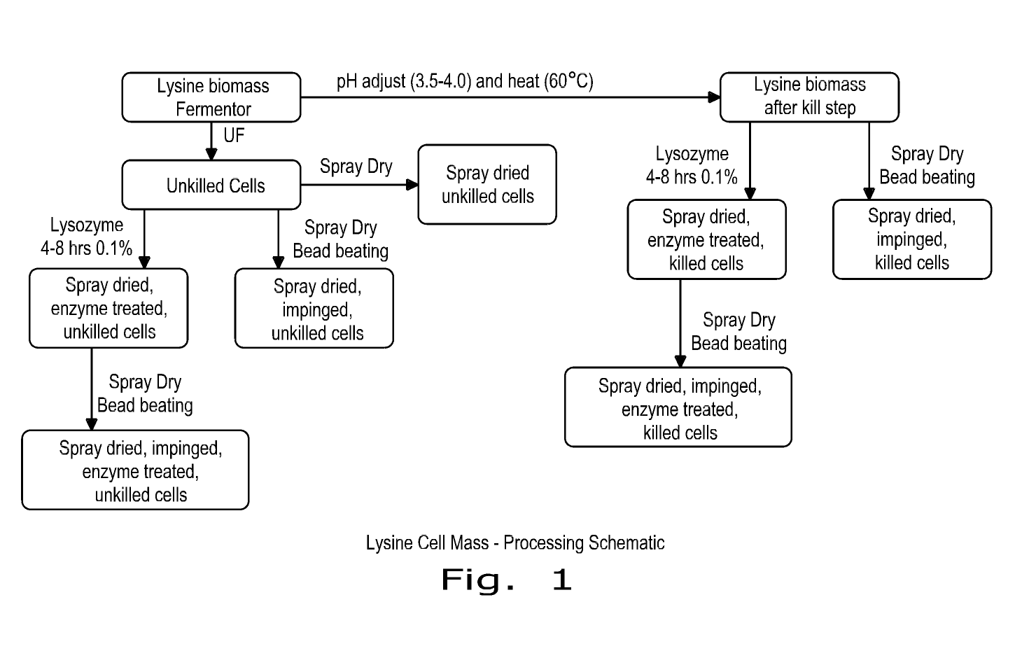

A series of studies were conducted to disrupt the cellular integrity of Corynebacterium glutamicum cells after lysine production and lysine removal. The fermentation cell mass was lysozyme -treated and subjected to mechanical impingement in various combinations. FIG. 1 shows a schematic of the methods of processing that were tested. The disruption of cell structure was indirectly measured using an in vitro pepsin enzyme assay commonly used to assess protein digestibility of feed ingredients. Greater pepsin digestibility values (%) indicate increased digestibility and potentially improved nutritional utility.

As shown in Table 3, Corynebacterium cell mass which was dried without having been first processed by enzyme exposure or impingement had low digestibility. The practice of mechanical disruption increased the pepsin digestibility of the cells by at least 19 percentage units, regardless of whether the starting cell mass was subjected to a kill step (heat+acid) and regardless of the equipment used to produce the dried cell mass. The addition of enzyme and the combination of enzymes increased the digestibility of the cell mass, but to a lesser extent as compared with impingement. The combination of enzyme and impingement increased the digestibility of the cells. The impingement (i.e., bead beating) described herein was performed using a Premier Mill, model #SM15 with zirconium beads having a size of between 0.87 mm and 1.0 mm. The impingement was done at a maximum speed of 278 RPM and the material was processed at an average rate of 1 liter per minute. In addition, cells that had been killed using heat and acid were exposed to a base treatment using calcium oxide to a pH of 10 and then returned to neutral using lactic acid. These base-treated cells also had increased digestibility. Cells, after being deactivated by heat and acid treatment, were disrupted using high-pressure homogenization. Cells were homogenized using a high pressure homogenizer where the pressure was 1000 Bar and dropped to atmospheric. Cells were processed twice through the homogenizer at a rate of 3.75 liters per minute. The disruption of the cells using homogenization also increased cellular digestibility as assessed using the pepsin digestibility assay.

TABLE 3
Digestibility of Corynebacterium cell mass subjected to various
methods of processing to produce a dry feed ingredient.

| Test material | Pepsin digestibility (%) |
|---|---|
| Spray dried, killed cells | 38.8 |
| Drum dried, killed cells | 38.2 |
| Spray dried, unkilled cells | 36.8 |
| Drum dried, unkilled cells | 35.5 |
| Impinged, spray dried, killed cells | 61.8 |
| Impinged, drum dried, killed cells | 66.7 |
| Impinged, spray dried, unkilled cells | 68.7 |
| Impinged, drum dried, unkilled cells | 66.8 |
| Spray dried, enzyme treated, killed cells | 66.1 |
| Drum dried, enzyme treated, killed cells | 54.9 |
| Spray dried, enzyme treated, unkilled cells | 45.5 |
| Drum dried, enzyme treated, unkilled cells | 60.7 |
| Base treated, killed cells | 70.0 |
| Homogenized cells | 57.5 |
| Dual enzyme treated (protease and | 43.1 |
| lysozyme), killed cells | |

### EXAMPLE 3

### Aquaculture Feeding Trial

The purpose of this study was to measure the growth response of channel catfish fed commercially feasible diets in which a plant protein (e.g., soybean meal) was substituted with Corynebacterium cell mass which had been disrupted and produced by various embodiments of the present invention.

A ten week growth trial was conducted with juvenile channel catfish (mean initial weight 11.93±0.076 g) to determine the response of the fish to being fed cell mass products of the present invention. The basal diet was formulated to contain 32% protein, 5% lipid, and was modeled after commercial feed formulations. The processed and dried cell masses of the present invention were substituted at 5 or 10% of the diet, and replaced soybean meal on a protein basis. Feeds were made under laboratory conditions and stored under refrigeration until required, and then fed to satiation using a fixed percent body weight across treatments. Diet formulations are presented in Table 4. At the conclusion of the growth trial final weights, feed conversion ratio (FCR) and survival were determined. The feeding experiment was concluded at week ten and the data of the feeding experiment are presented in Table 5.

The study diets were prepared in a feed laboratory using standard practices. Pre-ground dry ingredients and oil were mixed in a food mixer (Hobart Corporation, Troy, Ohio, USA) for 15 min. Hot water was blended into the mixture to attain a consistency appropriate for pelleting. Each diet was pressure pelleted using a meat grinder and a 3 mm die. After pelleting, diets were dried to a moisture content of 8-10% and stored at 4° C.

The basal diet was designed to contain about 32% protein and about 5% lipid using primarily plant based protein sources. The diet contained 4% menhaden fish meal to ensure palatability of the diets across the substitution levels. All diets were formulated to meet the nutritional requirements of the channel catfish I. punctatus. The basal diet was modified to produce 11 diets with the same level of protein, but with incremental levels (0, 5, and 10%) of the processed biomasses of the present invention. Soybean meal was removed on an iso-nitrogenous basis as the processed cell masses of the present invention were added and corn starch was used as a filler. Fish oil was adjusted to maintain similar lipid levels across the diets.

Juvenile channel catfish (mean initial weight 11.93±0.076 g) were randomly stocked into 75-L aquaria at 15 fish per aquarium. The individual aquaria were modular units serviced by a 2,500-L indoor water recirculation system. There were four replicates for diets 1 to 7 (basal, 10% inclusion level) and three replicates for each diet which contained particular cell masses at 5% inclusion (diets 8 to 11). Water temperature was maintained at about 28° C. using a submerged 3,600-W heater. Dissolved oxygen was maintained near saturation using air stones in each aquarium and the sump tank using a common air line was connected to a regenerative air blower. Dissolved oxygen and water temperature were measured twice a day using a YSI-55 digital oxygen/temperature meter (available from YSI Corporation, Yellow Springs, Ohio, USA) while pH, total ammonia nitrogen (TAN), and nitrite-N were measured once per week. The water pH was measured intermittently by an electronic pH meter (pH pen available from Fisher Scientific, Cincinnati, Ohio, USA). Total ammonia-nitrogen and nitrite-N were measured using the methods described by Solorzano (1969) and Parsons et al. (1985), respectively. Photoperiod was set at 14 h light and 10 h dark. Diets were offered to fish at 4.5 to 6.0% BW daily, according to fish size and divided into two equal feedings. Fish were weighed every other week. Feed ration was calculated based on % body weight and was constant for all treatment time intervals. The amount of feed offered per tank was adjusted each week based on growth and observation of the feeding response. At the end of the growth study, fish were counted and group weighed to determine weight gain, survival, and feed conversion ratio.

The data of this Example was subjected to a one-way analysis of variance to determine significant (P≦0.05) differences among the treatment means. Dunnett's t-test was used to compare individual treatment means to the control diet mean. The Student-Neuman Keuls' multiple range test was also used to distinguish significant differences among treatment means and paired contrasts were tested for 10% inclusion level of cell mass. Statistical analyses were conducted using the SAS system for windows (available from SAS Institute, Cary, N.C.).

The study diets are shown in Tables 4A and 4B where Corynebacterium cell mass, produced under different processing conditions described herein, was included in the diet at the indicated levels (5% and 10%). The fish performance of this Example is shown in Table 5. The data shows that the Corynebacterium cell mass produced in accordance of the present invention without further processing (#1, spray dried killed cells; 10% inclusion) led to a statistically significant reduction in fish performance. All processing conditions of the present invention performed on the Corynebacterium cell mass resulted in final fish weights that were higher than the fish fed the unprocessed cells. The improvement in the cell mass resulted in fish performance that was similar to that of the control fish. These data show that processing of cells resulted in an improved utility.

TABLE 4A
Composition of diets offered to catfish.

| Ingredient, % of | | | | | | |
|---|---|---|---|---|---|---|
| Diet | Diet 1 | Diet 2 | Diet 3 | Diet 4 | Diet 5 | Diet 6 |
| Fish meal | 4.00 | 4.00 | 4.00 | 4.00 | 4.00 | 4.00 |
| Soybean meal | 41.00 | 26.50 | 26.80 | 26.30 | 25.80 | 26.10 |
| Cottonseed meal | 15.00 | 15.00 | 15.00 | 15.00 | 15.00 | 15.00 |
| Fish oil | 2.05 | 1.66 | 1.92 | 2.11 | 2.09 | 1.97 |
| Corn starch | 0.15 | 5.04 | 4.48 | 4.79 | 5.31 | 5.13 |
| Corynebacteria | 0.00 | 10.00 | 10.00 | 10.00 | 10.00 | 10.00 |
| cell mass | | Spray dried, | Spray dried, | Spray | Spray dried, | Spray dried, |
| (treatment) | | enzyme | enzyme treated, | dried, | enzyme | enzyme treated, |
| | | treated, killed | impinged cells | unkilled | treated, | impinged, |
| | | cells | | cells | unkilled cells | unkilled cells |
| Whole wheat | 10.00 | 10.00 | 10.00 | 10.00 | 10.00 | 10.00 |
| Corn | 25.00 | 25.00 | 25.00 | 25.00 | 25.00 | 25.00 |
| Trace mineral | 0.50 | 0.50 | 0.50 | 0.50 | 0.50 | 0.50 |
| premix | | | | | | |
| Vitamin premix | 1.00 | 1.00 | 1.00 | 1.00 | 1.00 | 1.00 |
| 25% vitamin C | 0.06 | 0.06 | 0.06 | 0.06 | 0.06 | 0.06 |
| Calcium | 1.20 | 1.20 | 1.20 | 1.20 | 1.20 | 1.20 |
| phosphate | | | | | | |
| dibasic | | | | | | |
| Choline chloride | 0.04 | 0.04 | 0.04 | 0.04 | 0.04 | 0.04 |

TABLE 4B
Composition of diets offered to catfish.

| Ingredient, % of | | | | | |
|---|---|---|---|---|---|
| Diet | Diet 7 | Diet 8 | Diet 9 | Diet 10 | Diet 11 |
| Fish meal | 4.00 | 4.00 | 4.00 | 4.00 | 4.00 |
| Soybean meal | 25.40 | 33.80 | 33.70 | 33.40 | 33.20 |
| Cottonseed meal | 15.00 | 15.00 | 15.00 | 15.00 | 15.00 |
| Fish oil | 2.09 | 1.85 | 2.08 | 2.07 | 2.07 |
| Corn starch | 5.71 | 2.55 | 2.42 | 2.73 | 2.93 |
| Corynebacteria | 10.00 | 5.00 | 5.00 | 5.00 | 5.00 |
| cell mass | Spray | Spray dried, | Spray dried, | Spray dried, enzyme | Spray |
| (treatment) | dried | enzyme treated, | unkilled cells | treated, impinged, | dried, |
| | killed cells | impinged cells | | unkilled cells | killed cells |
| Whole wheat | 10.00 | 10.00 | 10.00 | 10.00 | 10.00 |
| Corn | 25.00 | 25.00 | 25.00 | 25.00 | 25.00 |
| Trace mineral | 0.50 | 0.50 | 0.50 | 0.50 | 0.50 |
| premix | | | | | |
| Vitamin premix | 1.00 | 1.00 | 1.00 | 1.00 | 1.00 |
| 25% vitamin C | 0.06 | 0.06 | 0.06 | 0.06 | 0.06 |
| Calcium phosphate | 1.20 | 1.20 | 1.20 | 1.20 | 1.20 |
| dibasic | | | | | |
| Choline chloride | 0.04 | 0.04 | 0.04 | 0.04 | 0.04 |

TABLE 5
Growth response of channel catfish during the feeding trial of this
Example.

| Processed | | | | | |
|---|---|---|---|---|---|
| Corynebacterium cells | % of | Final | | Feed conversion | |
| of | processed | weight | Weight | Ratio (FCR) (feed | |
| present invention | cells in diet | of fish | gain % | offered/weight gain) | Survival % |
| Control | 0 | 62.3 | 420 | 1.21 | 96 |
| Spray dried killed cells | 10 | 50.2 | 321 | 1.45 | 67 |
| Spray dried, enzyme | 10 | 59.9 | 401 | 1.25 | 97 |
| treated, killed cells | | | | | |
| Spray dried, enzyme | 10 | 60.5 | 409 | 1.23 | 98 |
| treated, impinged, | | | | | |
| unkilled cells | | | | | |
| Spray dried, unkilled | 10 | 55.7 | 372 | 1.28 | 100 |
| cells | | | | | |
| Spray dried, enzyme | 10 | 62.3 | 422 | 1.22 | 90 |
| treated, unkilled cells | | | | | |
| Spray dried, enzyme | 10 | 64.2 | 436 | 1.19 | 92 |
| treated, impinged, | | | | | |
| unkilled cells | | | | | |
| Spray dried killed cells | 5 | 57.4 | 383 | 1.27 | 96 |
| Spray dried, enzyme | 5 | 65.3 | 442 | 1.18 | 84 |
| treated, impinged | | | | | |
| unkilled cells | | | | | |
| Spray dried, unkilled | 5 | 62.4 | 424 | 1.20 | 89 |
| cells | | | | | |
| Spray dried, enzyme | 5 | 65.6 | 452 | 1.19 | 73 |
| treated, impinged, | | | | | |
| unkilled cells | | | | | |
| Significance (P value) | | 0.0075 | 0.0106 | 0.0101 | 0.185 |

### EXAMPLE 4

### Aquaculture feeding study.

This Example investigated the growth of channel catfish fed diets containing Corynebacteria cell masses which have been processed by various methods of the present invention. A 10 week growth study was conducted with juvenile channel catfish (mean initial weight 6.08±0.16 g) to determine the response of the fish to the processed cell mass products of the present invention. The basal diet was formulated to contain about 36% protein, about 6% lipid, and was modeled after commercial feed formulations. The processed cell masses of the present invention were substituted at 5 or 10% of the diet and replaced soybean meal on a protein basis. Feeds were made under laboratory conditions and stored under refrigeration until required. Throughout the growth trial, feed inputs were targeted near satiation using a fixed percent body weight across treatments. At the conclusion of the growth study, final weights, feed conversion ratio (FCR; feed offered/weight gain), and survival were determined. At the conclusion of 10 weeks, the fish were weighed and performance was assessed.

The basal diet was designed to contain about 36% protein and about 6% lipid using primarily plant based protein sources. The diet contained 4% menhaden fish meal to ensure palatability of the diets across the substitution levels. All diets were formulated to meet the nutritional requirements of the channel catfish I. punctatus. The basal diet was modified to produce 10 diets with the same level of protein, but with incremental levels (0, 5, and 10%) of the processed cell masses of the present invention. Soybean meal was removed on a iso-nitrogenous basis as the processed cell masses of the present invention were added and corn starch was used as a filler. Fish oil was adjusted to maintain similar lipid levels across the diets. The diets of this Example were prepared using standard practices. Pre-ground dry ingredients and oil were mixed in a food mixer (available from Hobart Corporation, Troy, Ohio, USA) for 15 min. Hot water was blended into the mixture to attain a consistency appropriate for pelleting. Each diet was pressure pelleted using a meat grinder and a 3 mm die. After pelleting, diets were dried to a moisture content of 8-10% and stored at 4° C.

Juvenile channel catfish (mean initial weight 6.08±0.16 g) were randomly stocked into 75-L aquaria which were modular components of a 2,500-L indoor recirculation system with 15 fish stocked per aquarium. Each diet was offered to four replicate groups of fish. In this system, water temperature was maintained at around 28° C. using a submerged 3,600-W heater (available from Aquatic Eco-Systems Inc., Apopka, Fla., USA). Dissolved oxygen was maintained near saturation using air stones in each aquarium and the sump tank using a common airline connected to a regenerative air blower. Dissolved oxygen and water temperature were measured twice a day using a YSI-55 digital oxygen/temperature meter (available from YSI corporation, Yellow Springs, Ohio, USA) while pH, total ammonia nitrogen (TAN), and nitrite-N were measured once per week. Water pH was measured intermittently by an electronic pH meter (pH pen available from Fisher Scientific, Cincinnati, Ohio, USA). Total ammonia-nitrogen and nitrite-N were measured using the methods described by Solorzano (1969) and Parsons et al. (1985), respectively. Photoperiod was set at 14 h light and 10 h dark. Diets were offered to fish at 3.5 to 5.0% BW daily according to fish size and divided into two equal feedings. Fish were weighed every other week. Feed ration offered was calculated based on a percentage of body weight and was held constant during each one-week interval and the feed ration was then adjusted each week based on growth and observation of the feeding response. At the end of the growth trial, fish were counted and group weighed to determine weight gain, survival, and feed conversion ratio.

In this Example, the primary heater failed which could not be immediately replaced. To maintain water temperatures, individual heaters were installed in two tanks per treatment to mitigate low temperatures. Due to individual heater problems, several aquaria had high mortality rates and have been excluded from the study. Hence, for a few treatments there are only 3 replicates.

Statistical analyses were conducted using SAS system for windows (available from SAS Institute, Cary, N.C.). Data were subjected to a one-way analysis of variance to determine significant (P≦0.05) differences among the treatment means. Dunnett's t-test was used to compare each treatment with the reference diet. The SAS output for the Student-Neuman Keuls' multiple range test was used to distinguish significant differences between treatment means and paired contrasts were performed for 10% inclusion level of each product.

The composition of the diets fed to the fish in this Example are presented in Tables 6A and 6B. The growth results of this Example are presented in Table 7.

TABLE 6A
Composition of study diets fed to catfish.

| Ingredient, % of | | | | | |
|---|---|---|---|---|---|
| Diet | Diet 1 | Diet 2 | Diet 3 | Diet 4 | Diet 5 |
| Fish meal | 6.00 | 6.00 | 6.00 | 6.00 | 6.00 |
| Soybean meal | 50.50 | 35.48 | 33.24 | 35.37 | 34.05 |
| Corn gluten protein | 6.00 | 6.00 | 6.00 | 6.00 | 6.00 |
| Fish oil | 3.46 | 3.20 | 3.50 | 3.20 | 3.35 |
| Corn starch | 0.44 | 5.72 | 7.49 | 5.83 | 7.00 |
| Corynebacteria cell | 0 | 10.00 | 10.00 | 10.00 | 10.00 |
| mass | | Spray dried, | Spray dried, | Spray dried, | Spray dried, |
| (treatment) | | killed cells | unkilled cells | impinged, killed | impinged, unkilled |
| | | | | cells | cells |
| Whole wheat | 10.00 | 10.00 | 10.00 | 10.00 | 10.00 |
| Corn | 20.00 | 20.00 | 20.00 | 20.00 | 20.00 |
| Trace mineral | 0.50 | 0.50 | 0.50 | 0.50 | 0.50 |
| premix | | | | | |
| Vitamin premix | 1.00 | 1.00 | 1.00 | 1.00 | 1.00 |
| 25% vitamin C | 0.06 | 0.06 | 0.06 | 0.06 | 0.06 |
| Calcium phosphate | 1.20 | 1.20 | 1.20 | 1.20 | 1.20 |
| dibasic | | | | | |
| Choline chloride | 0.04 | 0.04 | 0.04 | 0.04 | 0.04 |

TABLE 6B
Composition of study diets fed to catfish.

| Ingredient, % of | | | | | |
|---|---|---|---|---|---|
| Diet | Diet 6 | Diet 7 | Diet 8 | Diet 9 | Diet 10 |
| Fish meal | 6.00 | 6.00 | 6.00 | 6.00 | 6.00 |
| Soybean meal | 35.28 | 33.48 | 43.00 | 41.90 | 42.95 |
| Corn gluten | 6.00 | 6.00 | 6.00 | 6.00 | 6.00 |
| protein | | | | | |
| Fish oil | 3.43 | 3.52 | 3.33 | 3.48 | 3.33 |
| Corn starch | 5.69 | 7.20 | 3.07 | 3.93 | 3.12 |
| Corynebacteria | 10.00 | 10.00 | 5.00 | 5.00 | 5.00 |
| cell mass | Spray dried, | Spray dried, | Spray | Spray dried, | Spray dried, |
| (treatment) | enzyme treated, | enzyme treated, | dried, | unkilled cells | impinged, killed |
| | killed cells | unkilled cells | killed cells | | cells |
| Whole wheat | 10.00 | 10.00 | 10.00 | 10.00 | 10.00 |
| Corn | 20.00 | 20.00 | 20.00 | 20.00 | 20.00 |
| Trace mineral | 0.50 | 0.50 | 0.50 | 0.50 | 0.50 |
| premix | | | | | |
| Vitamin premix | 1.00 | 1.00 | 1.00 | 1.00 | 1.00 |
| 25% vitamin C | 0.06 | 0.06 | 0.06 | 0.06 | 0.06 |
| Calcium phosphate | 1.20 | 1.20 | 1.20 | 1.20 | 1.20 |
| dibasic | | | | | |
| Choline chloride | 0.04 | 0.04 | 0.04 | 0.04 | 0.04 |

TABLE 7
Growth response of channel catfish over 10 week growth trial.

| Processed | | | | | |
|---|---|---|---|---|---|
| Corynebacterium | % of | Final | | Feed conversion | |
| cells of | processed | weight | Weight | Ratio (FCR) (feed | |
| present invention | cells in diet | of fish | gain % | offered/weight gain) | Survival % |
| Control | 0 | 34.80 | 486 | 1.62 | 100 |
| Spray dried killed | 10 | 25.59 | 321 | 2.12 | 100 |
| cells | | | | | |
| Spray dried, unkilled | 10 | 28.89 | 375 | 1.95 | 98 |
| cells | | | | | |
| Spray dried, | 10 | 26.01 | 325 | 2.06 | 100 |
| impinged, killed cells | | | | | |
| Spray dried, | 10 | 19.31 | 214 | 2.83 | 100 |
| impinged, unkilled | | | | | |
| cells | | | | | |
| Spray dried, enzyme | 10 | 30.00 | 387 | 1.89 | 100 |
| treated, killed cells | | | | | |
| Spray dried, enzyme | 10 | 21.69 | 259 | 2.43 | 100 |
| treated, unkilled cells | | | | | |
| Spray dried killed | 5 | 31.18 | 407 | 1.72 | 97 |
| cells | | | | | |
| Spray dried, unkilled | 5 | 31.78 | 433 | 1.76 | 100 |
| cells | | | | | |
| Spray dried, | 5 | 33.97 | 463 | 1.67 | 100 |
| impinged, killed cells | | | | | |
| Significance (P | | 0.0001 | 0.0001 | 0.0001 | 0.6151 |
| value) | | | | | |

In this Example, the spray dried killed cells resulted in lower growth performance of channel catfish when included at 10% of the diet. All modifications of the original cell mass pursuant to the present invention led to a numerical improvement in growth performance when included at 5% of the diet compared to the linear regression between 0% and 10% spray dried killed cells. The feeding of impingement treated, unkilled cells resulted in lesser growth performance. It is possible that these results were due to degradation of the original material during delayed processing. Unkilled cells were held at neutral pH and the subsequent dried material resulted in lower growth performance than the killed material that underwent the same processing. This may indicate a potential loss in feeding value of the unkilled cell mass if it is held for extended periods of time before drying. Therefore, in one embodiment, live cells should be processed to further steps in the processing scheme within 12 hours. When looking at cells that were killed by pH adjustment and heat treatment prior to processing, there was an observed increase in final weight for all processed cell materials when cells were killed.

### EXAMPLE 5

### Poultry Feeding Study

This Example evaluated the growth performance of chicks fed rations containing the Corynebacterium cell mass which had been subjected to various treatment processes according to the present invention. The study used 500 New Hampshire×Columbian chicks (average initial weight d 8 post-hatch: 78.1 g). The study was conducted from days 8 to 29 post-hatch (21-d assay) with 25 treatments, five replicates per treatment, and 4 chicks per replicate. Pen weights were collected weekly, and feed intake and feed conversion were recorded on the same schedule. At the end of the study, one bird per pen was randomly selected for blood collection to assess clinical pathology parameters. Samples were subjected for clinical pathology analysis. Liver weight (absolute) and liver weight as a percentage of body weight were also determined on one bird per pen (i.e., the same bird randomly selected for blood collection).

Data was analyzed using SAS as a 1-way ANOVA with a Bonferroni correction, with diet being the only dependent variable in the model. Therefore, there were several instances where the main effect of the diet was significant, but the Bonferroni-corrected means separation did not display any differences among treatments (e.g., gain:feed results for 2 periods). This was considered logical considering the difference between the experiment-wise and comparison-wise error rate with a large number of treatments represented in the trial design.

In this Example, the poultry were fed the basal diet presented in Table 8. The Corynebacterium cell mass processed according to various embodiments of this invention was added to the basal diets at the expense of corn and soybean meal in the basal diet. With the addition of Corynebacterium cell mass processed according to various embodiments of this invention, the diets were adjusted to maintain diets containing 240 g of CP/kg of diet, 12.3-27.8 g lysine/kg of diet, and 2857-3131 kcal of metabolizable energy/kg of diet. CP refers to crude protein.

TABLE 8
Basal diet of this Example.

| Ingredient | Concentration (g/kg) |
|---|---|
| Corn | 615.60 |
| Soybean meal | 239.40 |
| Soy oil | 82.08 |
| Salt | 5.47 |
| Limestone | 19.15 |
| Di-calcium phosphate | 27.36 |
| Vitamin premix | 2.74 |
| Mineral premix | 2.05 |
| DL-Methionine | 2.74 |
| Choline chloride | 2.74 |
| Bacitracin | 0.68 |

The different Corynebacterium cell masses processed according to various embodiments of this invention used in this Example are presented in Table 9.

| Study Diet No. | Cell mass content (%) | Process performed on cell mass |
|---|---|---|
| 1 | 0 | Standard |
| 2 | 0 | Moderate lysine |
| 3 | 0 | High lysine |
| 4 | 1.25 | Spray dried, killed |
| 5 | 2.5 | Spray dried, killed |
| 6 | 5 | Spray dried, killed |
| 7 | 10 | Spray dried, killed |
| 8 | 1.25 | Spray dried, impinged, killed |
| 9 | 2.5 | Spray dried, impinged, killed |
| 10 | 5 | Spray dried, impinged, killed |
| 11 | 10 | Spray dried, impinged, killed |
| 12 | 1.25 | Drum dried, impinged, killed |
| 13 | 2.5 | Drum dried, impinged, killed |
| 14 | 5 | Drum dried, impinged, killed |
| 15 | 10 | Drum dried, impinged, killed |
| 16 | 2.5 | Spray dried, lysozyme treated, |
| | | killed |
| 17 | 5 | Spray dried, lysozyme treated, |
| | | killed |
| 18 | 1.25 | Spray dried, calcium lactate |
| | | treated, killed |
| 19 | 2.5 | Spray dried, calcium lactate |
| | | treated, killed |
| 20 | 2.5 | Spray dried, protease and |
| | | lysozyme treated, killed |
| 21 | 5 | Spray dried, protease and |
| | | lysozyme treated, killed |
| 22 | 10 | Spray dried, protease and |
| | | lysozyme treated, killed |
| 23 | 2.5 | Spray dried, homogenized, |
| | | killed |
| 24 | 5 | Spray dried, homogenized, |
| | | killed |
| 25 | 10 | Spray dried, homogenized, |
| | | killed |

The diets for the study treatments used in this Example and prepared using the various treated Corynebacterium cell masses of the present invention as follows. In each of the various dietary treatments, the Corynebacterium cell mass was added to the basal diet at the expense of corn and soybean meal as discussed herein. Study treatment 2 was calculated to contain 19.7 g of lysine/kg of the diet, which split the difference in lysine concentrations between the study diets having the lowest (Study Diet 1) and highest (Study Diet 25) concentrations of dietary lysine. The L-lysine HCl addition to study treatment 2 was calculated to contain 238.6 g of CP/kg, but the N contributed by the L-lysine HCl was not taken into account for this calculation. Study treatment 3 was calculated to contain 25.0 g of lysine/kg of the diet which was equivalent to the amount of lysine in study treatment 25 which had the highest concentration of dietary lysine. The L-lysine HCl addition to study treatment 3 was calculated to contain 238.6 g of CP/kg, but the N contributed by the L-lysine HCl was not taken into account for this calculation.

The study diets were as follows:
Study diet 1 corn-soybean meal basal diet of Table 8 (control);
Study diet 2 basal diet+6.9 g/kg of L-lysine HCl (mid-lysine control);
Study diet 3 basal diet+13.9 g/kg of L-lysine HCl (high-lysine control);
Study diet 4 basal diet+12.5 g/kg of spray dried, killed cell mass;
Study diet 5 basal diet+25.0 g/kg of spray dried, killed cell mass;
Study diet 6 basal diet+50.0 g/kg of spray dried, killed cell mass;
Study diet 7 basal diet+100.0 g/kg of spray dried, killed cell mass;
Study diet 8 basal diet+12.5 g/kg of spray dried, impinged, killed cell mass;
Study diet 9 basal diet+25.0 g/kg of spray dried, impinged, killed cell mass;
Study diet 10 basal diet+50.0 g/kg of spray dried, impinged, killed cell mass;
Study diet 11 basal diet+100.0 g/kg of spray dried, impinged, killed cell mass;
Study diet 12 basal diet+12.5 g/kg of drum dried, impinged, killed cell mass;
Study diet 13 basal diet+25.0 g/kg of drum dried, impinged, killed cell mass;
Study diet 14 basal diet+50.0 g/kg of drum dried, impinged, killed cell mass;
Study diet 15 basal diet+100.0 g/kg of drum dried, impinged, killed cell mass;
Study diet 16 basal diet+25.0 g/kg of spray dried, lysozyme treated, killed cell mass;
Study diet 17 basal diet+50.0 g/kg of spray dried, lysozyme treated, killed cell mass;
Study diet 18 basal diet+12.5 g/kg of spray dried, calcium lactate treated, killed cell mass;
Study diet 19 basal diet+25.0 g/kg of spray dried, calcium lactate treated, killed cell mass;
Study diet 20 basal diet+25.0 g/kg of spray dried, protease and lysozyme treated, killed cell mass;
Study diet 21 basal diet+50.0 g/kg of spray dried, protease and lysozyme treated, killed cell mass;
Study diet 22 basal diet+100.0 g/kg of spray dried, protease and lysozyme treated, killed cell mass;
Study diet 23 basal diet+25.0 g/kg of spray dried, homogenized, killed cell mass;
Study diet 24 basal diet+50.0 g/kg of spray dried, homogenized, killed cell mass;
Study diet 25 basal diet+100.0 g/kg of spray dried, homogenized, killed cell mass.
Study diets 1-3 represent typical treatment to treatment variations observed in poultry studies. Study diets 1-3 are within standard diet formulations and their only difference was the addition of lysine to match the level of lysine in the study diet having the highest amount of lysine (i.e., study diet 25). Increasing levels of unprocessed cell masses were in study diets 4-7 where growth performance of the poultry did not differ from the control diets, but there was a significant reduction in feed efficiency (gain:feed ratio) by the end of the study. The processes of modifying the cell masses such as impingement (diets 8-15), lysozyme treatment (diets 16 and 17), and the use of calcium hydroxide to elevate the pH and then lactic acid to lower the pH during processing (diets 18 and 19) all resulted in chick performance that were equivalent to the control diets. The processes of protease and lysozyme application did not restore chick performance (diets 20-22) as chick performance was similar in these diets to the unprocessed cell masses. However, it is possible that the protease and lysozyme applications may have suffered from microbial contamination that may have affected the results. The use of a two-stage homogenizer to disrupt the cells (diets 23-25) also did not affect performance as chick performance was similar in these diets as compared to the unprocessed cell mass diets.

TABLE 11A
Performance of chicks fed diets containing varying amounts of Corynebacteria cell masses.

| | Study diet | | | | | | | | | | | | |
|---|---|---|---|---|---|---|---|---|---|---|---|---|---|
| | 1 | 2 | 3 | 4 | 5 | 6 | 7 | 8 | 9 | 10 | 11 | 12 | 13 |
| Body weight | | | | | | | | | | | | | |
| gain, g/chick | | | | | | | | | | | | | |
| d 1-8 | 142_{ab} | 137_{abc} | 136_{abc} | 141_{ab} | 142_{ab} | 140_{abc} | 131_{bc} | 139_{abc} | 139_{abc} | 138_{abc} | 140_{abc} | 148_{ab} | 143_{ab} |
| d 8-15 | 179ₐ | 184ₐ | 181ₐ | 186ₐ | 196ₐ | 179ₐ | 178ₐ | 191ₐ | 184ₐ | 197ₐ | 184ₐ | 193ₐ | 190ₐ |
| d 15-22 | 215ₐ | 217ₐ | 214ₐ | 217ₐ | 224ₐ | 216ₐ | 199_{ab} | 219ₐ | 214ₐ | 198_{ab} | 203_{ab} | 226ₐ | 220ₐ |
| d 1-22 | 541_{ab} | 538_{ab} | 531_{ab} | 545_{ab} | 563_{ab} | 535_{ab} | 501_{b} | 549_{ab} | 537_{ab} | 533_{ab} | 527_{ab} | 567ₐ | 552_{ab} |
| Feed intake, | | | | | | | | | | | | | |
| g/chick | | | | | | | | | | | | | |
| d 1-8 | 194_{ab} | 192_{ab} | 182_{b} | 191_{ab} | 200_{ab} | 194_{ab} | 202_{ab} | 192_{ab} | 191_{ab} | 194_{ab} | 196_{ab} | 183_{b} | 197_{ab} |
| d 8-15 | 259_{ab} | 254_{ab} | 257_{ab} | 265_{ab} | 278_{ab} | 265_{ab} | 278_{ab} | 253_{ab} | 287_{ab} | 253_{ab} | 263_{ab} | 267_{ab} | 264_{ab} |
| d 15-22 | 372_{ab} | 378_{ab} | 373_{ab} | 394_{ab} | 399_{ab} | 400_{ab} | 417ₐ | 396_{ab} | 360_{ab} | 383_{ab} | 390_{ab} | 385_{ab} | 392_{ab} |
| d 1-22 | 838 | 824 | 813 | 850 | 876 | 859 | 897 | 841 | 838 | 831 | 849 | 835 | 853 |
| Gain: feed, | | | | | | | | | | | | | |
| g/kg | | | | | | | | | | | | | |
| d 1-8 | 733_{abc} | 715_{abc} | 754_{ab} | 741_{ab} | 714_{abc} | 718_{abc} | 645_{bcd} | 726_{abc} | 727_{abc} | 713_{abc} | 713_{abc} | 823ₐ | 726_{abc} |
| d 8-15 | 692 | 725 | 714 | 700 | 706 | 675 | 646 | 772 | 658 | 777 | 701 | 725 | 719 |
| d 15-22 | 587 | 573 | 579 | 554 | 562 | 540 | 479 | 554 | 604 | 517 | 521 | 587 | 560 |
| d 1-22 | 646_{ab} | 653_{ab} | 661_{ab} | 641_{ab} | 642_{ab} | 622_{abcd} | 559_{cd} | 655_{ab} | 640_{ab} | 642_{ab} | 620_{abcd} | 679ₐ | 648_{ab} |
| Liver weight, | 17.78 | 18.12 | 17.47 | 19.81 | 17.40 | 17.83 | 16.01 | 17.25 | 19.57 | 17.87 | 17.67 | 19.20 | 19.18 |
| g | | | | | | | | | | | | | |
| Liver weight, | 2.81 | 2.96 | 3.09 | 3.33 | 2.74 | 2.82 | 2.80 | 2.80 | 2.93 | 2.75 | 2.74 | 2.81 | 2.84 |
| % of BW | | | | | | | | | | | | | |

TABLE 11B
Performance of chicks fed diets containing varying amounts of Corynebacteria cell masses.

| | Study diet | | | | | | | | | | | |
|---|---|---|---|---|---|---|---|---|---|---|---|---|
| | 14 | 15 | 16 | 17 | 18 | 19 | 20 | 21 | 22 | 23 | 24 | 25 |
| Body weight | | | | | | | | | | | | |
| gain, g/chick | | | | | | | | | | | | |
| d 1-8 | 144_{ab} | 139_{abc} | 148_{ab} | 151ₐ | 144_{ab} | 137_{abc} | 143_{ab} | 141_{abc} | 124_{c} | 143_{ab} | 145_{ab} | 133_{bc} |
| d 8-15 | 194ₐ | 182ₐ | 187ₐ | 192ₐ | 197ₐ | 188ₐ | 188ₐ | 178ₐ | 138_{b} | 202ₐ | 186ₐ | 166_{b} |
| d 15-22 | 223ₐ | 214ₐ | 226ₐ | 217ₐ | 205_{ab} | 218ₐ | 220ₐ | 206_{ab} | 167_{b} | 205_{ab} | 217ₐ | 201_{ab} |
| d 1-22 | 560_{ab} | 534_{ab} | 561_{ab} | 559_{ab} | 546_{ab} | 542_{ab} | 550_{ab} | 524_{ab} | 428_{c} | 550_{ab} | 549_{ab} | 500_{b} |
| Feed intake, | | | | | | | | | | | | |
| g/chick | | | | | | | | | | | | |
| d 1-8 | 200_{ab} | 191_{ab} | 203_{ab} | 210ₐ | 201_{ab} | 194_{ab} | 206_{ab} | 201_{ab} | 210ₐ | 196_{ab} | 213ₐ | 216ₐ |
| d 8-15 | 272_{ab} | 256_{ab} | 261_{ab} | 298_{ab} | 255_{ab} | 264_{ab} | 357ₐ | 257_{ab} | 236_{b} | 263_{ab} | 264_{ab} | 262_{ab} |
| d 15-22 | 414ₐ | 387_{ab} | 397_{ab} | 372_{ab} | 396_{ab} | 378_{ab} | 390_{ab} | 376_{ab} | 338_{b} | 388_{ab} | 403_{ab} | 420ₐ |
| d 1-22 | 886 | 834 | 861 | 880 | 851 | 837 | 953 | 834 | 784 | 847 | 881 | 898 |
| Gain: feed, | | | | | | | | | | | | |
| g/kg | | | | | | | | | | | | |
| d 1-8 | 720_{abc} | 727_{abc} | 730_{abc} | 717_{abc} | 719_{abc} | 704_{abcd} | 694_{bcd} | 699_{bcd} | 589_{d} | 730_{abc} | 684_{bcd} | 617_{cd} |
| d 8-15 | 713 | 710 | 718 | 651 | 776 | 711 | 610 | 691 | 584 | 776 | 703 | 635 |
| d 15-22 | 538 | 555 | 570 | 595 | 516 | 576 | 563 | 548 | 493 | 525 | 539 | 481 |
| d 1-22 | 632_{abc} | 642_{ab} | 652_{ab} | 636_{abc} | 642_{ab} | 648_{ab} | 593_{bcd} | 628_{abc} | 546_{d} | 650_{ab} | 623_{abcd} | 558_{cd} |
| Liver weight, | 17.54 | 18.15 | 17.23 | 20.36 | 17.99 | 19.21 | 19.71 | 17.45 | 16.30 | 18.98 | 18.82 | 16.23 |
| g | | | | | | | | | | | | |
| Liver weight, | 2.85 | 2.80 | 2.79 | 2.88 | 2.88 | 2.97 | 2.84 | 2.90 | 2.83 | 2.75 | 2.83 | 2.69 |
| % of BW | | | | | | | | | | | | |

### EXAMPLE 6

### Poultry Feeding Trial

This study evaluated the growth performance of chicks fed Corynebacterium cell mass processed by various methods of the present invention. Basal diet formulations are presented in Table 12 and the processes applied to the cell mass is presented in Table 13. The impingement was done with a Premier Mill, model #SM15, having zirconium beads between 0.87-1.0 mm at a maximum speed of 278 RPM. The material was processed through the mill at an average rate of 1 liter/minute.

In this trial, 260 New Hampshire x Columbian chicks with an average initial weight at 7 days post-hatch of 81.9 g were used. The study was conducted during days 7 to 27 post-hatch (21-d assay); there were 13 treatments and 5 replicates per treatment and 4 chicks per replicate. Pen weights were collected weekly, and feed intake and feed conversion were recorded on the same schedule. At the conclusion of the study, all birds were euthanized by CO2 asphyxiation. Performance results are presented in Table 14.

TABLE 12
Basal diet fed to chicks.

| Ingredient | Level g/kg | Concentration level g/kg |
|---|---|---|
| Corn | 446.5 | 536.5 |
| Soybean meal | 279.70 | 336.10 |
| Soy oil | 60.00 | 72.1 |
| Salt | 4.00 | 4.8 |
| Limestone | 14.00 | 16.8 |
| Dicalcium phosphate | 20.00 | 24.0 |
| Vitamin premix | 2.00 | 2.4 |
| Mineral premix | 1.50 | 1.8 |
| L-lysine HCl | 0.00 | 0 |
| DL-methionine | 2.00 | 2.4 |
| Choline chloride | 2.00 | 2.4 |
| Bacitracin | 0.50 | 0.6 |
| Total | 832.20 | 1000.0 |

Data were analyzed as a 1-way ANOVA with means separated using LSMEANS adjusted by Tukey's, with diet being the only dependent variable in the model.

TABLE 13
Dietary treatments.

| Study Diet No. | Cell mass content (%) | Process performed on cell mass |
|---|---|---|
| 1 | 0 | Basal diet (control) |
| 2 | 5 | Spray dried, killed |
| 3 | 10 | Spray dried, killed |
| 4 | 5 | Flash dried, killed |
| 5 | 10 | Flash dried, killed |
| 6 | 5 | Drum dried, killed |
| 7 | 10 | Drum dried, killed |
| 8 | 5 | Spray dried, impinged, killed |
| 9 | 10 | Spray dried, impinged, killed |
| 10 | 5 | Flash dried, impinged, killed |
| 11 | 10 | Flash dried, impinged, killed |
| 12 | 5 | Drum dried, impinged, killed |
| 13 | 10 | Drum dried, impinged, killed |

Cell masses were added to the basal diets at the expense of corn and soybean meal, which were adjusted to maintain diets containing 240 g of CP/kg of diet, 19.8 g lysine/kg of diet, and 2946-3106 kcal of metabolizable energy/kg of diet.

TABLE 12A
Performance of chicks fed Corynebacterium cell mass.

| | Study Diet No. | | | | | | |
|---|---|---|---|---|---|---|---|
| Response variable | 1 | 2 | 3 | 4 | 5 | 6 | 7 |
| Bird count, initial | 20 | 20 | 20 | 20 | 20 | 20 | 20 |
| Bird count, final | 20 | 20 | 20 | 20 | 20 | 20 | 20 |
| Body weight, initial g | 82 | 82 | 82 | 82 | 82 | 82 | 82 |
| Body weight, final g | 621^{ab} | 617^{ab} | 546^{c} | 626^{ab} | 589^{abc} | 619^{ab} | 578^{bc} |
| Body weight gain, | | | | | | | |
| g/chick/day | | | | | | | |
| d 1-7 | 20 | 18 | 18 | 20 | 19 | 19 | 18 |
| d 7-14 | 25^{a} | 25^{a} | 21^{b} | 25^{a} | 23^{ab} | 25^{a} | 23^{ab} |
| d 14-21 | 32^{ab} | 33^{ab} | 27^{c} | 32^{ab} | 31^{abc} | 33^{ab} | 30^{bc} |
| d 1-21 | 26^{abc} | 25^{abc} | 22^{d} | 26^{abc} | 24^{bcd} | 26^{abc} | 24^{cd} |
| Feed intake, | | | | | | | |
| g/chick/day | | | | | | | |
| d 1-7 | 29 | 28 | 30 | 29 | 29 | 28 | 28 |
| d 7-14 | 43 | 43 | 45 | 46 | 45 | 41 | 41 |
| d 14-21 | 56 | 57 | 56 | 58 | 60 | 55 | 56 |
| d 1-21 | 42 | 42 | 44 | 45 | 45 | 41 | 42 |
| Gain: feed, g/kg | | | | | | | |
| d 1-7 | 682^{abc} | 658^{abc} | 584^{c} | 680^{abc} | 631^{bc} | 700^{ab} | 632^{abc} |
| d 7-14 | 588^{ab} | 585^{ab} | 479^{c} | 549^{abc} | 525^{bc} | 604^{ab} | 565^{ab} |
| d 14-21 | 581^{ab} | 581^{ab} | 489^{e} | 558^{abc} | 512^{cd} | 591^{a} | 537^{bcd} |
| d 1-21 | 606^{abc} | 599^{abc} | 507^{e} | 581^{bcd} | 542^{de} | 619^{ab} | 567^{cd} |

^{abcde}Means within a row with different superscript are statistically different P < 0.05

TABLE 12B
Performance of chicks fed Corynebacterium cell mass.

| | | | | | | | | Overall |
|---|---|---|---|---|---|---|---|---|
| Response | Study Diet No. | | | | | | Pooled | Model P- |
| variable | 8 | 9 | 10 | 11 | 12 | 13 | SEM | value |
| Initial weight, g | 82 | 82 | 82 | 82 | 82 | 82 | 0.7670 | 1.0000 |
| Final weight, g | 639^{a} | 624^{ab} | 631^{ab} | 622^{ab} | 634^{ab} | 620^{ab} | 11.9955 | <0.0001 |
| Body weight | | | | | | | | |
| gain, g/chick/d | | | | | | | | |
| d 1-7 | 20 | 20 | 20 | 20 | 20 | 20 | 0.5239 | 0.0067 |
| d 7-14 | 26^{a} | 26^{a} | 26^{a} | 25^{a} | 26^{a} | 25^{a} | 0.5106 | <0.0001 |
| d 14-21 | 34^{a} | 32^{ab} | 33^{ab} | 32^{ab} | 33^{a} | 32^{ab} | 0.6857 | <0.0001 |
| d 1-21 | 27^{a} | 26^{abc} | 26^{ab} | 26^{abc} | 26^{ab} | 26^{abc} | 0.4680 | <0.0001 |
| Feed intake, | | | | | | | | |
| g/chick/d | | | | | | | | |
| d 1-7 | 27 | 29 | 29 | 30 | 28 | 28 | 0.7214 | 0.1115 |
| d 7-14 | 42 | 42 | 41 | 42 | 41 | 42 | 1.2627 | 0.0805 |
| d 14-21 | 56 | 56 | 55 | 56 | 57 | 56 | 1.3248 | 0.5320 |
| d 1-21 | 42 | 42 | 42 | 43 | 42 | 42 | 0.8453 | 0.1059 |
| Gain: feed, g/kg | | | | | | | | |
| d 1-7 | 735^{a} | 690^{ab} | 680^{abc} | 662^{abc} | 707^{ab} | 693^{ab} | 21.0995 | 0.0010 |
| d 7-14 | 620^{a} | 618^{a} | 628^{a} | 607^{ab} | 630^{ab} | 602^{ab} | 16.7638 | <0.0001 |
| d 14-21 | 600^{a} | 573^{ab} | 594^{a} | 572^{ab} | 588^{a} | 567^{ab} | 10.0325 | <0.0001 |
| d 1-21 | 636^{a} | 614^{abc} | 625^{ab} | 603^{abc} | 628^{ab} | 606^{abc} | 10.2338 | <0.0001 |

^{abcde}Means within a row with different superscript are statistically different P < 0.05

When the unprocessed cell mass was included in diets at 10%, growth performance was decreased (diets 3, 5, and 7). Significant reductions in gain:feed were also observed as a result of feeding 10% cell mass, regardless of drying technology. The use of impingement (diets 8-13) demonstrated an alleviation of the reduction in both performance and gain:feed.

### EXAMPLE 7

### Effect of Feeding Corynebacterium Cell Mass to Swine

A total of 96 pigs (6.8±0.3 kg body weight (BW); ˜28 days of age) were used in a randomized complete block design with 4 dietary treatments. Blocks were 6 initial BW categories. The study unit was a pen with 2 barrows and 2 gilts per pen. Each treatment had 6 block-replicates.

The dietary treatments used were a positive control which was a typical nursery diet according to industry standards and the positive control with varying amounts of Corynebacterium cell mass present at 5%, 7.5%, and 10%.

Variables of response included pig performance and some blood parameters. Pig performance was measured as BW, weight gain (ADG), feed intake (ADFI), and gain to feed ratio (G:F). Body weight and feed disappearance were recorded on days 0, 7, 15, 21, 28 and 35.

The ADG and ADFI were calculated per pen on a pig-day basis, and expressed as daily average per pig. Performance data were analyzed and reported in metric units.

The following blood serum parameters were measured in 2 pigs per pen on day 35: albumin, blood urea nitrogen (BUN), calcium, cholesterol, creatinine phosphokinase (CPK), creatinine, globulin, glucose, lactate dehydrogenase, phosphorus, potassium, serum glutamic oxaloacetic transaminase (SGOT; also known as aspartate aminotransferase or AST), sodium, and total serum protein.

The diets were formulated to meet or exceed the nutritional requirements of the pig (Swine NRC, 2012), and to provide similar concentrations of metabolizable energy (ME) and nutrients across all dietary treatments. The diet formulations included minimum concentrations of Lys, Ca and P; a Lys to ME ratio; and minimum ratios of Ile, Met, S amino acids, Thr, Trp and Val to Lys (National Swine Nutrition Guide, 2010). Amino acids were provided on a standardized ileal digestibile (SID) basis. Diets did not include antibiotics, pre-, or pro-biotics. All diets were in pellet form. The feeding program included 3 phases of 7, 14 and 14 days, respectively, for phases 1, 2 and 3.

The pigs used were PIC dam C29×sire 337. Pigs were weaned and moved into the research facilities at about 21 days of age, and then were given 7-day adaptation period prior to starting the experiment. A commercial diet was fed to all pigs during that time. Seven days after weaning (about 28 days of age), pigs were weighed and randomized to dietary treatments; this was considered day 0 of the study.

On day 35 (last day of the study), 1 barrow and 1 gilt per pen were randomly selected to collect a blood sample. Samples were collected via jugular venipuncture, following the block sequence from 1 to 6. Samples were kept on ice during collection, and processed to obtain serum. Serum samples were froze at about −10° C. and shipped to the lab for analysis. Three pigs were removed from the study due to mortality on days 13, 20 and 22. One of those pigs belonged to treatment 1, and the other 2 pigs to treatment 4. Those pigs were previously treated for respiratory problems not related to dietary treatments.

The data of this study were analyzed as a randomized complete block design, using the MIXED procedure of SAS. Block was used as a random effect in the model. Analysis of residuals for the performance data showed normal distribution and no outliers were detected. Blood data analysis of residuals showed 16 records (2% of the total) as outliers (3 times interquartile range beyond first and third quartile), and were excluded from the analysis. Analysis of outliers by interquartile range as a reference uses both a measurement of scale and location points that are not easily influenced by extreme observations. The following 4 variables had to be transformed to achieve normal distribution of the data: BUN (x³), CPK (x⁻¹), globulin and SGOT (x⁻²). Transformed data were analyzed using the GLIMMIX procedure of SAS, following same experimental design; those treatment means and their standard errors were reverse transformed to their original units for reporting purposes. Linear, quadratic, and cubic polynomial analyses were included to assess the effect of increasing inclusions of dietary Corynebacterium cell mass. Pair-wise comparisons were included for individual treatment comparisons.

The pig performance (BW, ADG, ADFI, and G:F) in this study showed a negative dose-dependent response to the increasing inclusion of dietary Corynebacterium cell mass (linear effect, P<0.001) over the 35 days in the study as shown in Table 13.

TABLE 13
Cumulative pig performance from day 0 to day 35.

| | Dietary Corynebacterium cell mass inclusion | | | | |
|---|---|---|---|---|---|
| Item | 0% | 5% | 7.5% | 10% | SEM |
| ADG, | 0.616^{a} | 0.567^{ab} | 0.532^{b} | 0.474^{c} | 0.021 |
| kg/d* | | | | | |
| ADFI, | 0.808^{a} | 0.784^{ab} | 0.733^{bc} | 0.682^{c} | 0.030 |
| kg/d* | | | | | |
| G:F, | 763^{a} | 724^{b} | 726^{b} | 695^{c} | 7 |
| g/kg* | | | | | |

*Linear effect, P < 0.001.
^{abc}Within rows, treatment means with different superscript differ (P < 0.05).

As shown in Table 14, the inclusion of the Corynebacterium cell mass of the present invention at 5% of the diet reduced (P<0.01) ADG from days 0 to 7 by 24%, as compared to pigs fed the control diet (0% Corynebacterium cell mass) , but no further differences were detected on ADG between pigs fed the control diet vs. 5% Corynebacterium cell mass. In contrast, inclusion of Corynebacterium cell mass at either 7.5% or 10% of the diet reduced (P<0.05) ADG in every phase of the study, as compared to pigs fed the control diet. The ADFI between pigs fed 0 vs. 5% of the Corynebacterium cell mass did not differ. However, between those 2 treatments, cumulative G:F at every time point was lower (P>0.01) in pigs fed 5% of the Corynebacterium cell mass. Larger doses (7.5 or 10%) of dietary Corynebacterium cell mass reduced further the ADFI and G:F, as compared to pigs fed the control diet.

TABLE 14
LS means of pig performance in this Example.

| | Treatment number | | | | | | | | | | | | | | |
|---|---|---|---|---|---|---|---|---|---|---|---|---|---|---|---|
| | 1 | 2 | 3 | 4 | | | | | | | | | | | |
| | Corynebacterium cell mass | | | | | Overall trt | Contrast p-values | | | Pairwise p-values | | | | | |
| | 0% | 5% | 7.5% | 10% | SEM | p-values | Linear | Quadratic | Cubic | 1 vs 2 | 1 vs 3 | 1 vs 4 | 2 vs 3 | 2 vs 4 | 3 vs 4 |
| Body weights, kg | | | | | | | | | | | | | | | |
| day 0 | 6.9 | 6.8 | 6.8 | 6.9 | 0.3 | | | | | | | | | | |
| day 7 | 9.7 | 9.0 | 8.9 | 8.7 | 0.4 | 0.001 | <0.001 | 0.189 | 0.448 | 0.002 | 0.001 | <0.001 | 0.869 | 0.289 | 0.366 |
| day 15 | 13.3 | 12.3 | 12.0 | 11.4 | 0.6 | 0.001 | <0.001 | 0.946 | 0.626 | 0.016 | 0.003 | <0.001 | 0.429 | 0.025 | 0.114 |
| day 21 | 17.1 | 15.8 | 15.2 | 14.3 | 0.7 | 0.001 | <0.001 | 0.756 | 0.939 | 0.038 | 0.003 | <0.001 | 0.235 | 0.015 | 0.156 |
| day 28 | 22.5 | 20.9 | 19.9 | 18.8 | 0.9 | <0.001 | <0.001 | 0.559 | 0.981 | 0.016 | <0.001 | <0.001 | 0.101 | 0.002 | 0.071 |
| day 35 | 28.7 | 26.6 | 25.4 | 23.9 | 1.0 | <0.001 | <0.001 | 0.553 | 0.907 | 0.010 | <0.001 | <0.001 | 0.113 | 0.002 | 0.050 |
| Weight gain, kg/hd/d | | | | | | | | | | | | | | | |
| days 0-7 | 0.406 | 0.308 | 0.302 | 0.270 | 0.023 | 0.001 | <0.001 | 0.338 | 0.440 | 0.004 | 0.002 | <0.001 | 0.844 | 0.199 | 0.271 |
| days 7-15 | 0.446 | 0.421 | 0.390 | 0.331 | 0.022 | 0.002 | <0.001 | 0.093 | 0.830 | 0.337 | 0.033 | <0.001 | 0.209 | 0.002 | 0.030 |
| days 15-21 | 0.615 | 0.585 | 0.518 | 0.478 | 0.035 | 0.039 | 0.006 | 0.420 | 0.586 | 0.517 | 0.049 | 0.009 | 0.159 | 0.032 | 0.394 |
| days 21-28 | 0.764 | 0.724 | 0.680 | 0.614 | 0.026 | <0.001 | <0.001 | 0.113 | 0.934 | 0.141 | 0.006 | <0.001 | 0.113 | 0.001 | 0.025 |
| days 28-35 | 0.895 | 0.820 | 0.791 | 0.734 | 0.027 | 0.005 | 0.001 | 0.735 | 0.713 | 0.064 | 0.015 | 0.001 | 0.457 | 0.036 | 0.146 |
| days 7-21 | 0.518 | 0.492 | 0.445 | 0.392 | 0.025 | 0.003 | <0.001 | 0.154 | 0.812 | 0.369 | 0.021 | 0.001 | 0.121 | 0.003 | 0.086 |
| days 0-21 | 0.481 | 0.430 | 0.397 | 0.351 | 0.023 | 0.002 | <0.001 | 0.465 | 0.904 | 0.078 | 0.007 | <0.001 | 0.231 | 0.009 | 0.100 |
| days 21-35 | 0.763 | 0.716 | 0.670 | 0.613 | 0.024 | 0.001 | <0.001 | 0.243 | 0.970 | 0.123 | 0.006 | <0.001 | 0.133 | 0.003 | 0.063 |
| days 7-35 | 0.670 | 0.632 | 0.590 | 0.528 | 0.022 | 0.000 | <0.001 | 0.116 | 0.930 | 0.151 | 0.005 | <0.001 | 0.120 | 0.001 | 0.026 |
| days 0-35 | 0.616 | 0.567 | 0.532 | 0.474 | 0.021 | 0.000 | <0.001 | 0.228 | 0.771 | 0.061 | 0.004 | <0.001 | 0.178 | 0.002 | 0.029 |
| Feed intake, kg/hd/d | | | | | | | | | | | | | | | |
| days 0-7 | 0.436 | 0.406 | 0.375 | 0.371 | 0.024 | 0.105 | 0.018 | 0.907 | 0.596 | 0.290 | 0.043 | 0.032 | 0.282 | 0.222 | 0.878 |
| days 7-15 | 0.600 | 0.570 | 0.541 | 0.486 | 0.029 | 0.010 | 0.002 | 0.226 | 0.823 | 0.338 | 0.067 | 0.002 | 0.342 | 0.012 | 0.081 |
| days 15-21 | 0.761 | 0.759 | 0.694 | 0.645 | 0.037 | 0.042 | 0.012 | 0.176 | 0.575 | 0.968 | 0.133 | 0.015 | 0.143 | 0.017 | 0.270 |
| days 21-28 | 0.996 | 0.971 | 0.905 | 0.877 | 0.038 | 0.012 | 0.002 | 0.398 | 0.399 | 0.473 | 0.018 | 0.004 | 0.075 | 0.016 | 0.438 |
| days 28-35 | 1.305 | 1.242 | 1.174 | 1.110 | 0.041 | 0.007 | 0.001 | 0.448 | 0.815 | 0.213 | 0.017 | 0.001 | 0.183 | 0.016 | 0.211 |
| days 7-21 | 0.668 | 0.651 | 0.607 | 0.552 | 0.032 | 0.015 | 0.003 | 0.164 | 0.865 | 0.611 | 0.083 | 0.003 | 0.200 | 0.009 | 0.123 |
| days 0-21 | 0.591 | 0.569 | 0.529 | 0.491 | 0.028 | 0.019 | 0.003 | 0.291 | 0.780 | 0.478 | 0.055 | 0.004 | 0.196 | 0.018 | 0.210 |
| days 21-35 | 1.029 | 1.002 | 0.936 | 0.884 | 0.035 | 0.005 | 0.001 | 0.211 | 0.586 | 0.464 | 0.021 | 0.001 | 0.090 | 0.006 | 0.182 |
| days 7-35 | 0.904 | 0.879 | 0.823 | 0.764 | 0.033 | 0.003 | 0.001 | 0.138 | 0.755 | 0.459 | 0.027 | 0.001 | 0.112 | 0.003 | 0.095 |
| days 0-35 | 0.808 | 0.784 | 0.733 | 0.682 | 0.030 | 0.006 | 0.001 | 0.171 | 0.749 | 0.444 | 0.028 | 0.001 | 0.122 | 0.005 | 0.117 |
| Gain: feed, g/kg | | | | | | | | | | | | | | | |
| days 0-7 | 929 | 758 | 802 | 726 | 24 | <0.001 | <0.001 | 0.158 | 0.029 | <0.001 | 0.002 | <0.001 | 0.217 | 0.366 | 0.042 |
| days 7-15 | 744 | 739 | 719 | 682 | 14 | 0.028 | 0.000 | 0.113 | 0.939 | 0.816 | 0.223 | 0.007 | 0.318 | 0.012 | 0.086 |
| days 15-21 | 811 | 768 | 742 | 742 | 19 | 0.076 | 0.013 | 0.568 | 0.669 | 0.138 | 0.024 | 0.025 | 0.357 | 0.367 | 0.985 |
| days 21-28 | 768 | 747 | 754 | 701 | 16 | 0.022 | 0.009 | 0.178 | 0.171 | 0.307 | 0.473 | 0.004 | 0.752 | 0.033 | 0.016 |
| days 28-35 | 687 | 662 | 673 | 661 | 11 | 0.253 | 0.115 | 0.552 | 0.262 | 0.092 | 0.352 | 0.085 | 0.414 | 0.965 | 0.391 |
| days 7-21 | 777 | 754 | 731 | 711 | 11 | 0.003 | <0.001 | 0.490 | 0.749 | 0.153 | 0.009 | 0.001 | 0.139 | 0.012 | 0.215 |
| days 0-21 | 815 | 755 | 748 | 715 | 11 | 0.000 | <0.001 | 0.726 | 0.305 | 0.002 | 0.001 | 0.001 | 0.675 | 0.024 | 0.056 |
| days 21-35 | 742 | 715 | 716 | 693 | 7 | 0.001 | <0.001 | 0.760 | 0.153 | 0.010 | 0.013 | 0.001 | 0.909 | 0.028 | 0.022 |
| days 7-35 | 742 | 720 | 717 | 691 | 7 | 0.001 | <0.001 | 0.381 | 0.258 | 0.007 | 0.021 | 0.001 | 0.771 | 0.010 | 0.019 |
| days 0-35 | 763 | 724 | 726 | 695 | 7 | 0.000 | <0.001 | 0.871 | 0.083 | 0.002 | 0.003 | 0.001 | 0.849 | 0.013 | 0.009 |

ADM Animal Nutrition Research - S13101

As shown in Table 15, no differences were detected among treatments for the following blood parameters: calcium, phosphorus, creatine phosphokinase, glucose, lactate dehydrogenase, and total protein. When compared against pigs fed the control diet, inclusion of the Corynebacterium cell mass at 5% of the diet reduced (P<0.001) blood urea nitrogen, and the magnitude of that difference increased as increasing levels of the Corynebacterium cell mass were fed. In contrast, pigs fed 5% Corynebacterium cell mass had more (P<0.01) cholesterol, but larger doses of Corynebacterium cell mass did not increase it further. The serum creatinine concentration decreased (P<0.01) in pigs fed either 7.5 or 10% Corynebacterium cell mass, whereas albumin, potassium and sodium decreased (P<0.05) only in in pigs fed 10% Corynebacterium cell mass, as compared to those fed without it. However, all blood constituents were within normally observed ranges.

TABLE 15
LS means of blood parameters.

| | Treatment number | | | | | | | | | | | | | | |
|---|---|---|---|---|---|---|---|---|---|---|---|---|---|---|---|
| | 1 | 2 | 3 | 4 | | | | | | | | | | | |
| | Corynebacterium cell mass | | | | | Overall trt | Contrast p-values | | | Pairwise p-values | | | | | |
| | 0% | 5% | 7.5% | 10% | SEM | p-values | Linear | Quadratic | Cubic | 1 vs 2 | 1 vs 3 | 1 vs 4 | 2 vs 3 | 2 vs 4 | 3 vs 4 |
| Body weights, kg | | | | | | | | | | | | | | | |
| day 0 | 6.9 | 6.8 | 6.8 | 6.9 | 0.3 | | | | | | | | | | |
| day 7 | 9.7 | 9.0 | 8.9 | 8.7 | 0.4 | <0.001 | <0.001 | 0.189 | 0.448 | 0.002 | 0.001 | <0.001 | 0.869 | 0.289 | 0.366 |
| day 15 | 13.3 | 12.3 | 12.0 | 11.4 | 0.6 | 0.001 | <0.001 | 0.946 | 0.626 | 0.016 | 0.003 | <0.001 | 0.429 | 0.025 | 0.114 |
| day 21 | 17.1 | 15.8 | 15.2 | 14.3 | 0.7 | 0.001 | <0.001 | 0.756 | 0.939 | 0.038 | 0.003 | <0.001 | 0.235 | 0.013 | 0.156 |
| day 28 | 22.5 | 20.9 | 19.9 | 18.8 | 0.9 | <0.001 | <0.001 | 0.559 | 0.981 | 0.016 | <0.001 | <0.001 | 0.101 | 0.002 | 0.071 |
| day 35 | 28.7 | 26.6 | 25.4 | 23.9 | 1.0 | <0.001 | <0.001 | 0.553 | 0.907 | 0.010 | <0.001 | <0.001 | 0.113 | 0.002 | 0.050 |
| Weight gain, kg/hd/d | | | | | | | | | | | | | | | |
| days 0-7 | 0.406 | 0.308 | 0.302 | 0.270 | 0.023 | 0.001 | <0.001 | 0.338 | 0.440 | 0.004 | 0.002 | <0.001 | 0.844 | 0.199 | 0.271 |
| days 7-15 | 0.446 | 0.421 | 0.390 | 0.331 | 0.022 | 0.002 | <0.001 | 0.093 | 0.830 | 0.337 | 0.036 | <0.001 | 0.209 | 0.002 | 0.030 |
| days 15-21 | 0.615 | 0.585 | 0.518 | 0.478 | 0.035 | 0.033 | 0.006 | 0.420 | 0.586 | 0.517 | 0.040 | 0.009 | 0.159 | 0.032 | 0.394 |
| days 21-28 | 0.764 | 0.724 | 0.680 | 0.614 | 0.026 | <0.001 | <0.001 | 0.113 | 0.934 | 0.141 | 0.006 | <0.001 | 0.113 | 0.001 | 0.025 |
| days 28-35 | 0.895 | 0.820 | 0.791 | 0.734 | 0.027 | 0.006 | 0.001 | 0.735 | 0.713 | 0.064 | 0.015 | 0.001 | 0.457 | 0.036 | 0.146 |
| days 7-21 | 0.518 | 0.492 | 0.445 | 0.392 | 0.025 | 0.003 | <0.001 | 0.154 | 0.812 | 0.369 | 0.021 | 0.001 | 0.121 | 0.003 | 0.086 |
| days 0-21 | 0.481 | 0.430 | 0.397 | 0.351 | 0.023 | 0.002 | <0.001 | 0.465 | 0.904 | 0.078 | 0.007 | <0.001 | 0.231 | 0.009 | 0.100 |
| days 21-35 | 0.763 | 0.716 | 0.670 | 0.613 | 0.024 | 0.001 | <0.001 | 0.243 | 0.970 | 0.123 | 0.006 | <0.001 | 0.133 | 0.003 | 0.063 |
| days 7-35 | 0.670 | 0.632 | 0.590 | 0.528 | 0.022 | 0.000 | <0.001 | 0.116 | 0.930 | 0.151 | 0.006 | <0.001 | 0.120 | 0.001 | 0.026 |
| days 0-35 | 0.616 | 0.567 | 0.532 | 0.474 | 0.021 | 0.000 | <0.001 | 0.228 | 0.771 | 0.061 | 0.004 | <0.001 | 0.178 | 0.002 | 0.029 |
| Feed intake, kg/hd/d | | | | | | | | | | | | | | | |
| days 0-7 | 0.436 | 0.406 | 0.375 | 0.371 | 0.024 | 0.105 | 0.018 | 0.907 | 0.596 | 0.290 | 0.043 | 0.032 | 0.282 | 0.222 | 0.878 |
| days 7-15 | 0.600 | 0.570 | 0.541 | 0.486 | 0.029 | 0.010 | 0.002 | 0.226 | 0.823 | 0.338 | 0.067 | 0.002 | 0.342 | 0.012 | 0.081 |
| days 15-21 | 0.761 | 0.759 | 0.694 | 0.645 | 0.037 | 0.042 | 0.012 | 0.176 | 0.575 | 0.968 | 0.133 | 0.016 | 0.143 | 0.017 | 0.270 |
| days 21-28 | 0.996 | 0.971 | 0.905 | 0.877 | 0.038 | 0.012 | 0.002 | 0.398 | 0.399 | 0.473 | 0.013 | 0.004 | 0.075 | 0.016 | 0.438 |
| days 28-35 | 1.305 | 1.242 | 1.174 | 1.110 | 0.041 | 0.007 | 0.001 | 0.448 | 0.815 | 0.213 | 0.017 | 0.001 | 0.183 | 0.016 | 0.211 |
| days 7-21 | 0.668 | 0.651 | 0.607 | 0.552 | 0.032 | 0.015 | 0.003 | 0.164 | 0.865 | 0.611 | 0.083 | 0.003 | 0.200 | 0.009 | 0.123 |
| days 0-21 | 0.591 | 0.569 | 0.529 | 0.491 | 0.028 | 0.019 | 0.003 | 0.291 | 0.780 | 0.478 | 0.055 | 0.004 | 0.196 | 0.018 | 0.210 |
| days 21-35 | 1.029 | 1.002 | 0.936 | 0.884 | 0.035 | 0.005 | 0.001 | 0.211 | 0.586 | 0.464 | 0.021 | 0.001 | 0.090 | 0.006 | 0.182 |
| days 7-35 | 0.904 | 0.879 | 0.823 | 0.764 | 0.033 | 0.003 | 0.001 | 0.138 | 0.755 | 0.459 | 0.027 | 0.001 | 0.112 | 0.003 | 0.095 |
| days 0-35 | 0.808 | 0.784 | 0.733 | 0.682 | 0.030 | 0.005 | 0.001 | 0.171 | 0.749 | 0.444 | 0.023 | 0.001 | 0.122 | 0.005 | 0.117 |
| Gain: feed, g/kg | | | | | | | | | | | | | | | |
| days 0-7 | 929 | 758 | 802 | 726 | 24 | <0.001 | <0.001 | 0.158 | 0.028 | <0.001 | 0.002 | <0.001 | 0.217 | 0.366 | 0.042 |
| days 7-15 | 744 | 739 | 719 | 682 | 14 | 0.028 | 0.009 | 0.113 | 0.939 | 0.816 | 0.223 | 0.007 | 0.318 | 0.012 | 0.086 |
| days 15-21 | 811 | 768 | 742 | 742 | 19 | 0.076 | 0.013 | 0.568 | 0.669 | 0.138 | 0.024 | 0.025 | 0.357 | 0.367 | 0.985 |
| days 21-28 | 768 | 747 | 754 | 701 | 16 | 0.022 | 0.009 | 0.178 | 0.171 | 0.307 | 0.473 | 0.004 | 0.752 | 0.033 | 0.018 |
| days 28-35 | 687 | 662 | 673 | 661 | 11 | 0.253 | 0.115 | 0.552 | 0.262 | 0.092 | 0.352 | 0.085 | 0.414 | 0.965 | 0.391 |
| days 7-21 | 777 | 754 | 731 | 711 | 11 | 0.003 | <0.001 | 0.490 | 0.749 | 0.153 | 0.008 | 0.001 | 0.139 | 0.012 | 0.215 |
| days 0-21 | 815 | 755 | 748 | 715 | 11 | 0.000 | <0.001 | 0.726 | 0.305 | 0.002 | 0.001 | 0.001 | 0.675 | 0.024 | 0.056 |
| days 21-35 | 742 | 715 | 716 | 693 | 7 | 0.001 | <0.001 | 0.760 | 0.153 | 0.010 | 0.013 | 0.001 | 0.909 | 0.028 | 0.022 |
| days 7-35 | 742 | 720 | 717 | 691 | 7 | 0.001 | <0.001 | 0.381 | 0.258 | 0.037 | 0.021 | 0.001 | 0.771 | 0.010 | 0.019 |
| days 0-35 | 763 | 724 | 726 | 695 | 7 | 0.000 | <0.001 | 0.871 | 0.083 | 0.002 | 0.003 | 0.001 | 0.849 | 0.013 | 0.009 |

ADM Animal Nutrition Research - S13101

The negative effect of the Corynebacterium cell mass on pig performance decreased over time. For example, dietary inclusion of Corynebacterium cell mass at the lowest dose (5%) had an initial negative effect on ADG and G:F (days 0 to 7), but no further differences were detected between pigs fed 0 vs. 5% Corynebacterium cell mass for the following individual time periods, days 7 to 15, 15 to 21, 21 to 28, and 28 to 35. Similarly, the relative difference in performance between pigs fed 0 vs. 10% Corynebacterium cell mass decreased over time. In fact, no differences among treatments were detected in G:F from days 28 through 35. As the nutritional specifications of Corynebacterium cell mass were derived from broilers, it is possible that the concentration of either, or both ME and SID amino acids were overestimated. Nursery pigs are very sensitive to energy and amino acids concentrations in the diet, mainly because of the physical limitations for feed intake. A dilution of both ME and SID amino acids in the diet, as more Corynebacterium cell mass was included, may help to explain the effects on performance and blood parameters.

This Example indicated that increasing concentrations of dietary Corynebacterium cell mass reduced pig performance in a dose-dependent fashion. The reduction in growth rate was driven by loss in feed efficiency, and in a smaller extent by reduced feed intake; these effects were reduced as pigs matured. Dietary treatments also affected some blood parameters. These results suggest that the nutritional specifications of Corynebacterium cell mass were possibly overestimated for pigs, as they were derived from broiler research.

### EXAMPLE 8

### Effect of Feeding Corynebacterium Cell Mass to Fish

An 8-week feeding study was performed to evaluate the response of tilapia fed lysine biomass products (i.e., Corynebacterium cell mass). The study diets included the processed cell masses of the present invention (processed as described in Table 16) at 10% dry weight, 87% dry weight of a commercial catfish formulation (available from Rangen, Inc. of Angelton, Tex.) having 32% crude protein, and 3% dry weight of carboxymethyl cellulose. The cell mass, the commercial catfish formulation, and the carboxymethyl cellulose were thoroughly mixed in dry form, water was added, the resulting meal was processed through a meat grinder to produce 3-mm pellets, and the pellets were dried by forced air to less than 10% moisture by weight.

The study was conducted in 38-L aquaria operating in a recirculating mode using young, rapidly growing Oreochromis niloticus with an initial average weight of 4.2 g/fish. The temperature was maintained at 28° C., +/−1° C., by conditioning ambient air. A water flow rate through the culture system was sufficient to maintain optimal water quality. A sand filtration system was also used to remove particulate material and nitrogenous wastes were removed with a biofilter. Supplemental aeration was used to maintain dissolved oxygen levels close to saturation and other water quality parameters were routinely monitored to keep them at acceptable levels. A 12 hr/12 hr light/dark cycle was maintained with fluorescent lights controlled by timers.

Each dietary study was fed to triplicate groups of 15 fish per aquarium at a rate approaching apparent satiation twice daily for 8 weeks. Weight gain (% of initial weight), feed efficiency, and survival were monitored by group weighing the fish each week throughout the study.

At the end of the study, the fish were weighed. Three fish per aquarium were used to obtain one pooled plasma sample per tank and the plasma samples were analyzed for the small animal panel of chemical measurements. Another three fish per aquarium were used to dissect their liver sample in order to measure hepatosomatic index (liver weight/body weight ratio) as known in the art.

For the studies of this Example, appropriate statistical procedures were applied using the general linear model of the statistical analysis system. The individual aquaria/tanks were the basic unit of observation for all statistical analysis. Results of this study and how the Corynebacterium cell mass fed to the fish were processed are shown in Table 16.

TABLE 16

| | | Feed efficiency | | |
|---|---|---|---|---|
| | | ratio | | |
| | Weight | (grams | Hepatosomatic | Survival |
| Diet | gain (%) | gained/grams fed) | index (%) | (%) |
| Control | 301 | 0.54 | 2.31 | 84 |
| (commercial formulation) | | | | |
| Killed, spray dried cells + | 304 | 0.51 | 2.23 | 80 |
| control | | | | |
| Killed, drum dried cells + | 332 | 0.54 | 2.24 | 73 |
| control | | | | |
| Unkilled, drum dried cells + | 247 | 0.45 | 2.10 | 84 |
| control | | | | |
| Killed, disrupted, spray | 303 | 0.51 | 2.30 | 82 |
| dried cells + control | | | | |
| Killed, disrupted, drum | 316 | 0.53 | 2.49 | 76 |
| dried cells + control | | | | |
| Unkilled, disrupted, drum | 331 | 0.57 | 1.93 | 93 |
| dried cells + control | | | | |
| Killed, enzyme treated, | 313 | 0.51 | 2.26 | 78 |
| spray dried cells + control | | | | |
| Killed, enzyme treated, | 339 | 0.55 | 2.25 | 84 |
| drum dried cells + control | | | | |
| Unkilled, enzyme treated, | 256 | 0.46 | 2.22 | 78 |
| drum dried cells + control | | | | |
| P-value | 0.295 | 0.040 | 0.256 | 0.406 |
| PSE | 15.7 | 0.01 | 0.07 | 3.2 |

The present invention has been described with reference to certain exemplary and illustrative embodiments, compositions and uses thereof. However, it will be recognized by persons having ordinary skill in the art that various substitutions, modifications or combinations of any of the exemplary embodiments may be made without departing from the scope of the invention. Thus, the invention is not limited by the description of the exemplary and illustrative embodiments, but rather by the appended claims.

1. A method of feeding an animal comprising:
feeding a disrupted cell mass to an animal at an amount of at least 0.5% of the animal's diet.

2. The method according to claim 1, further comprising disrupting the cell mass obtained from a fermentation process, thus producing the disrupted cell mass.

3. The method according to claim 1 or claim 2, wherein the cell mass comprises cells of a Corynebacterium origin.

4. The method according to claim 1 or claim 2, wherein the animal is a fish.

5. The method according to claim 1 or claim 2, wherein the animal is selected from the group consisting of poultry, swine, and a ruminant.

6. The method according to claim 1 or claim 2, further comprising separating whole cells from a fermentation process, thus producing the cell mass.

7. The method according to claim 2, wherein disrupting the cell mass comprises an act selected from the group consisting of enzyme treatment, chemical treatment, physical disruption, or combinations of any thereof.

8. The method according to claim 7, wherein the act comprises the physical disruption and is selected from the group consisting of sonication, homogenization, impingement, bead beating, high pressure gradient, autoclaving, heating, freezing, freeze/thawing, French pressing, alkalization, acidification, treatment with a surfactant, treatment with a chelating agent, or combinations of any thereof.

9. The method according to claim 7, wherein the act comprises the enzyme treatment.

10. The method according to claim 7, wherein the act comprises the enzyme treatment and the physical treatment.

11. The method according to claim 10, wherein the physical treatment comprise heating, pH adjustment, or a combination thereof.

12. The method according to claim 1, further comprising drying the disrupted cell mass.

13. The method according to claim 1, wherein the disrupted cell mass is in a liquid form or a wet paste.

14. The method according to claim 1, further comprising densifying the disrupted cell mass.

15. The method according to claim 1, wherein the disrupted cell mass is fed to the animal at an amount of 0.5-20% by weight of the animal's diet.

16. The method according to claim 1, wherein the disrupted cell mass is fed to the animal at an amount of 1-15% by weight of the animal's diet.

17. The method according to claim 1, wherein the disrupted cell mass is fed to the animal at an amount of 2-10% by weight of the animal's diet.

18. The method according to claim 1, wherein the disrupted cell mass is of a fungus, a bacteria, a yeast, or an algae origin.

19. The method according to claim 1, wherein the cell mass is of a Corynebacterium origin, a Brevibacterium origin, a Lactococcus origin, a Bacillus origin, a Candida origin, a Saccharomyces origin, an Aspergillus origin, a Schizosaccharomyces origin, an Escherichia origin, a Rhizopus origin, a Torulaspora origin, a Yarrowia origin, a Brettanomyces origin, a Zygosaccharomyces origin, an Actinomycetes origin, a Dietzia origin, Bifidobacterium origin, or combinations of any thereof.

20. The method according to claim 1, wherein the disrupted cell mass is used as a protein source for the animal.
